(19) United States
(12) Patent Application Publication
(10) Pub. No.: US 2018/0170306 A1
(43) Pub. Date: Jun. 21, 2018

(54) METHOD AND SYSTEM OF IDENTIFYING BUCKLE SWITCH TRANSMITTER POSITION

(71) Applicant: Honda Motor Co., Ltd., Tokyo (JP)

(72) Inventor: William E. SEAMAN, IV, East Liberty, OH (US)

(21) Appl. No.: 15/379,751

(22) Filed: Dec. 15, 2016

(51) Int. Cl. B60R 22/48

(52) U.S. Cl. CPC B60R 22/48; B60C 23/0427; B60R 2022/4866

(57) ABSTRACT

A system and a method for a receiver in a motor vehicle to learn a position of a buckle switch is disclosed. The buckle switch indicates a buckled state or an unbuckled state of a buckle on a seat belt mounted to a removable seat. The method includes the steps of placing the receiver into a learning mode, indicating that the position of the buckle switch is to be learned, activating the buckle switch, and indicating that the learning is complete.

### TECHNICAL FIELD

The embodiments disclosed herein are directed to the field of removable seats for motor vehicle.

### BACKGROUND

In motor vehicles equipped with removable seats, buckle switch information can be transmitted wirelessly from a seat assembly to a vehicle's control system, such as information related to whether the seat belt in a specific seat is buckled. However, several such modules might exist within one vehicle. Therefore, the vehicle must be able to distinguish one wireless module from another so as to identify the seat position. This can be accomplished by a pre-programmed unique position identifier, which receives signals from the buckle switch transmitter and interprets the signals as a particular seat position. However, this leads to additional parts to control, additional processes during the manufacture of the transmitter, and decreased flexibility. There is therefore a need for a system and method for identifying wireless buckle switch transmitter position addresses for identifying each seat position.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a method for a receiver in a motor vehicle to learn a position of a buckle switch is disclosed. The buckle switch indicates a buckled state or an unbuckled state of a buckle on a seat belt mounted to a removable seat. The method includes the steps of placing the receiver into a learning mode, indicating that the position of the buckle switch is to be learned, activating the buckle switch, and indicating that the learning is complete.

According to another aspect, a seat belt buckle alert system for a motor vehicle includes a receiver for controlling the seat belt buckle alert system, and a removable seat. The removable seat includes a seat belt located within the removable seat, a buckle adapted to be buckled and unbuckled, the buckle securing the seat belt to the seat. The system further includes a switch within the buckle indicating whether the buckle is in a buckled state or an unbuckled state, a transmitter, and wherein the transmitter transmits a signal from the removable seat that is received by the receiver.

### BRIEF DESCRIPTION OF THE DRAWINGS

FIG. 1 is a top view illustration of the interior of a motor vehicle equipped with removable seats.

FIG. 2 is a view of dashboard of a motor vehicle.

FIG. 3 is a schematic view of one embodiment of a buckle switch location system.

FIG. 4 is a flowchart showing an embodiment of a method of training the buckle switch location system.

FIG. 5 is a schematic view of another embodiment of a buckle switch location system.

FIG. 6 is a schematic view of yet another embodiment of a buckle switch location system.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

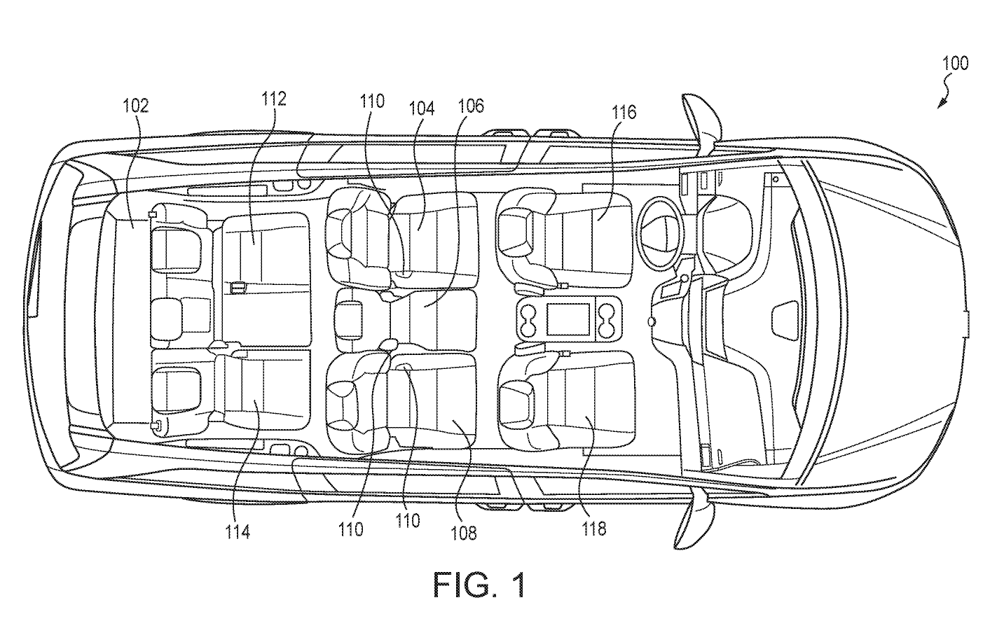

FIG. 1 is an illustration of an interior 102 of a motor vehicle 100 equipped with removable seats 104, 106, 108. By removing and rearranging the removable seats 104, 106, 108 in the motor vehicle 100, the user has greater flexibility to arrange seating for a number of different passengers, such as children, or to create greater room for mixed uses, such as passengers and cargo. For safety reasons, each of the removable seats 104, 106, 108 in the motor vehicle 100 is equipped with an integrated seat belt buckle 110 for securing the passengers to the seat.

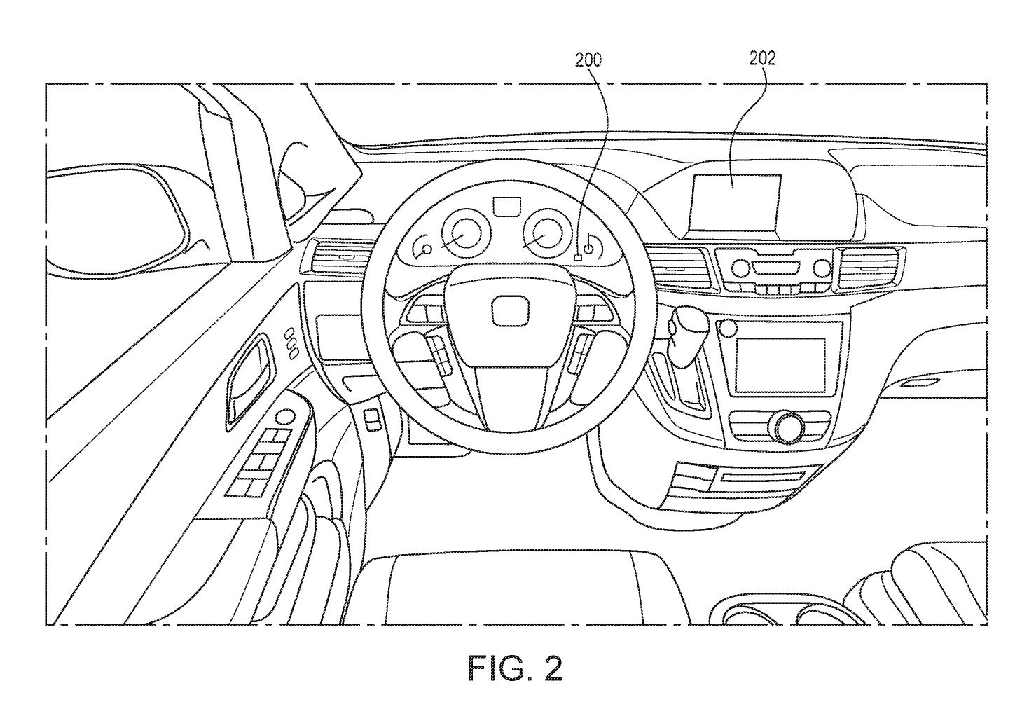

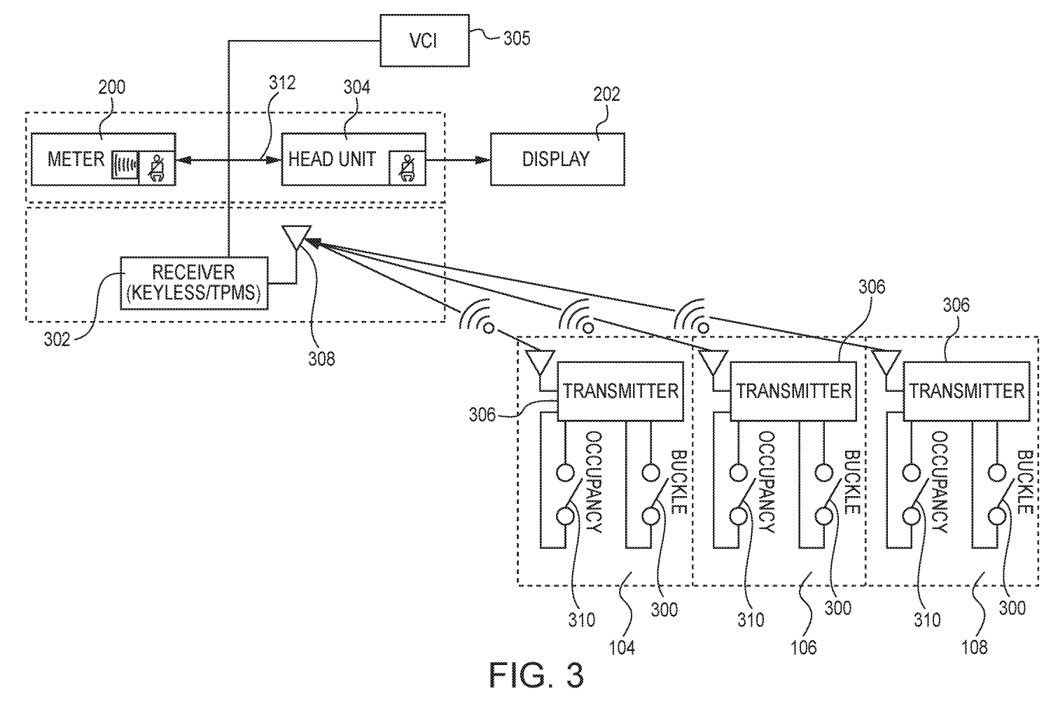

In modern motor vehicles, removable seats 104, 106, 108 and fixedly secured seats 112, 114, 116, 118 may be equipped with a buckle switch, illustrated in FIG. 3, that alerts the driver of the buckled status of all seats 104, 106, 108, 112, 114, 116, 118 with passengers in the motor vehicle 100. An example of a display is illustrated in FIG. 2, which may display a seat belt icon as a warning that one of the seats 104, 106, 108, 112, 114, 116, 118 is unbuckled. The seat belt icon may be located on a dedicated meter display 200, or as part of a shared-function display 202. However, the warning is most effective when the specific seat with the unbuckled seat belt may be identified. Therefore, there is a need to be able to identify the position of each seat 104, 106, 108, 112, 114, 116, 118 so that they may be properly identified, even after the removable seats 104, 106, 108 have been repositioned in the motor vehicle 100 by the user or a seat has been serviced.

FIG. 3 illustrates one embodiment of a system and method for identifying the position of removable seats 104, 106, 108 located in the motor vehicle 100. The buckle switch 300 information can be transmitted wirelessly from the seat to the vehicle 100. Several such modules might exist within one motor vehicle 100. However, the vehicle must be able to distinguish one wireless module from another so that the seat position can be identified. This may be accomplished by the application of an enhanced buckle switch system.

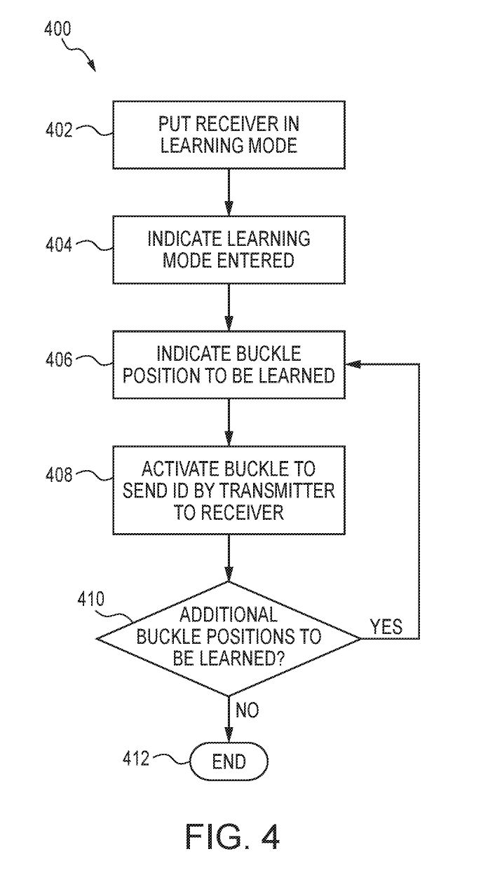

The buckle switch position may be learned in the following manner, illustrated in the flowchart 400 in FIG. 4. In a first step 402, a receiver 302 is put into a learning mode via a command, such as an audio command, by entering a code into a head unit 304 that is in communication with the receiver 302, by actuating a button on the head unit 304 or receiver 302, or by any other method known to one skilled in the art. In a second step 404, the receiver 302 provides that learning mode is entered. In a third step 406, as illustrated in the embodiment in FIG. 3, the receiver 302 indicates which buckle 110 position is to be learned by providing indicia to the user through a meter 200 or through the head unit 304 and an attached display 202. In the fourth step 408, the buckle switch 300 in the buckle 110 located in the receiver indicated buckle position is then activated to send an identification message with a buckle transmitter 306 to the receiver 302, via antenna 308. The identification message is preferably in a simple format of the type typically sent in automotive applications as known to those skilled in the art. In the embodiment illustrated in FIG. 3, the receiver 302 is the receiver associated with the keyless entry and tire pressure monitor system, which is electrically connected to a dedicated meter 200 and/or the head unit 304 of the motor vehicle 100, which may display indicia in a shared display 202 in the motor vehicle 100. Although the receiver 302 associated with the keyless entry and tire pressure monitor system is discussed herein, any other receiver in the motor vehicle, or a dedicated receiver, may be used as determined by one skilled in the art.

As illustrated in the fifth step 410, the buckle transmitter 306 may be activated by buckling and unbuckling the buckle 110 a fixed number of times in a repeated fashion, a button may be actuated, or any other method known to one skilled in the art may be employed, in order to learn all the positions of buckles 110 in the motor vehicle 100. When completed, as shown in the sixth step 412, the process may end upon completion of the learning. In the embodiment illustrated in FIG. 3, the removable seats 104, 106, 108 each include a seat weight sensor switch 310 and a buckle switch 300 that are in electrical connection with the buckle transmitter 306. When the seat weight sensor switch 310 is closed, indicating the seat 104, 106, 108 is occupied, the closing of the buckle switch 300 activates the buckle transmitter 306. The buckle transmitter 306 may be a RF module of the type typically known to those skilled in the art that operates on either a 433.92 MHz or 315 MHz frequency operating on a power source ranging from 3 to 9 volts, such as CR2032 batteries which are used frequently in automotive applications. The buckle transmitter 306 may be positioned in the seat 104, 106, 108 or within the buckle 110.

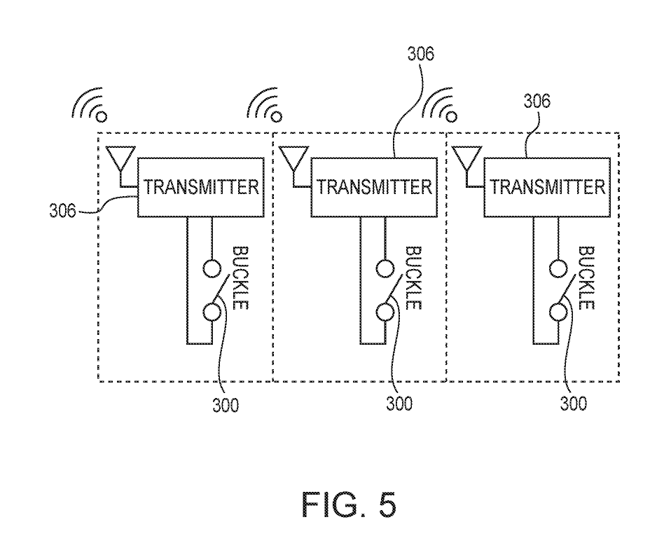

In an alternate embodiment, as illustrated in FIG. 5, the closing of the buckle switch 300 may activate the buckle transmitter 306 alone and absent a seat weight sensor switch.

With continuing reference to FIG. 3, after the identification message is received by the receiver 302, the receiver 302 may communicate with the meter 200 and/or the head unit 304 over a vehicle bus 312 to indicate to the user that the learning is complete and move on to the next position of a buckle 110 to be learned until all positions have been learned.

The method of messaging the receiver 302 can either be on the screen of an off-board tool (not shown), on the dedicated meter 200 within the motor vehicle 100, or on the shared use electronic display 202 within the motor vehicle 100. Additionally, the command can be given to the receiver 302 to learn only one of the positions, which would be useful in the case that one of the removable seats 104, 106, 108 is replaced, such as in service or repair.

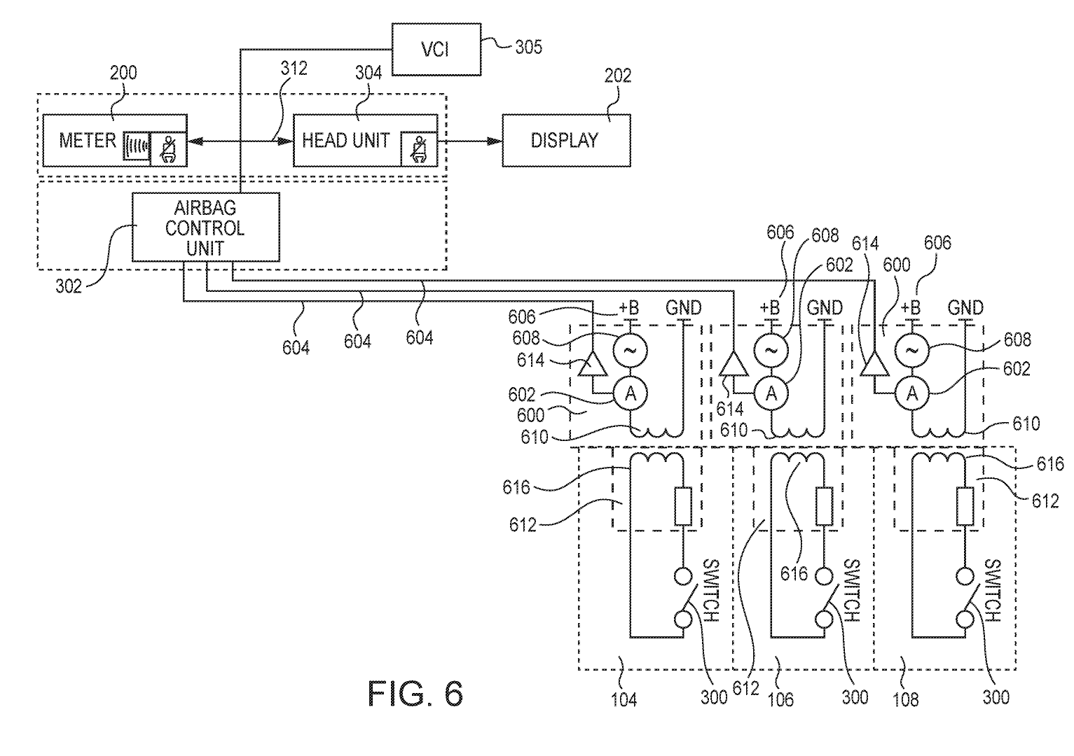

FIG. 6 illustrates an alternate embodiment of the system and method for identifying the position of removable seats 104, 106, 108 located in the motor vehicle 100. In the alternate embodiment, a magnetic field generator 600 and current ammeter 602 is mounted beneath each seat location and in wired connection with the receiver 302 by wires 604. A battery 606 provides a voltage source, and an A/C current waveform generator 608 creates an A/C current in the circuit. An ammeter 602 measures current in the circuit, and a loop 610 creates a magnetic resonance that interacts through induction with a current in an associated magnetic field receiver 612. The output of the ammeter 602 is sent to a comparator 614, which compares the current level to a fixed value. The comparator 614 is connected to the receiver 302 via a wire 604. As illustrated in FIG. 6, the receiver 302, which is further connected to the head unit 304 via a bus 312, may be the airbag control unit, or any other suitable receiver within the motor vehicle 100 known to those skilled in the art.

Within the removable seat 104, 106, 108, the buckle switch 300 forms a circuit with the magnetic field receiver 612 and current loop 616. The current loop 616 is in close proximity to a current loop 610 in the magnetic field generator 600. The two circuits are in a magnetic resonance with each other. When the buckle switch 300 is closed, current flows through the magnetic field receiver 612, which creates a change in current in the magnetic field generator 600. This change is detected by the ammeter 602 in the magnetic field generator 600. The comparator 614 may detect the change in current, thereby causing a signal to be conveyed to the receiver 302, which identifies the removable seat 104, 106, 108 in the location. As with the first embodiment, the learning may be repeated until all seat locations in the vehicle 100 are learned.

The method illustrated in FIG. 4 may be repeated anytime seats 104, 106, 108 in the motor vehicle 100 are moved, removed, repositioned, replaced, or repaired. As autonomous vehicles become more prevalent, the method may also be expanded to be applicable to all seats 104, 106, 108, 112, 114, 116, 118 in the motor vehicle 100, which may include additional possible seating arrangements without restrictions on the position of any of the seats 104, 106, 108, 112, 114, 116, 118, particularly what is traditionally viewed as the driver's seat 116.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method for a receiver in a motor vehicle to learn a position of a buckle switch, the buckle switch indicating a buckled state or an unbuckled state of a buckle on a seat belt mounted to a removable seat, the method comprising the steps of:
placing the receiver into a learning mode;
indicating that the position of the buckle switch is to be learned;
activating the buckle switch; and
indicating that the learning is complete.

2. The method of claim 1 wherein the motor vehicle comprises a plurality of buckle switches, further comprising the step of:
repeating until positions of the plurality of buckle switches have been learned.

3. The method of claim 1 wherein the step of activating the buckle switch further comprises the step of:
buckling and unbuckling the buckle a fixed number of times to open and close the buckle switch the fixed number of times.

4. The method of claim 3 further comprising the step of:
sending a signal to the receiver from a transmitter in communication with the buckle switch.

5. The method of claim 1 wherein the step of indicating that the learning is complete further comprises the step of:
displaying indicia on a dedicated meter in the motor vehicle.

6. The method of claim 1 wherein the step of indicating that the learning is complete further comprises the step of:
displaying indicia on a shared display in the motor vehicle.

7. A seat belt buckle alert system for a motor vehicle, comprising:
a receiver for controlling the seat belt buckle alert system;
a removable seat, the removable seat comprising:
a seat belt located within the removable seat,
a buckle adapted to be buckled and unbuckled, the buckle securing the seat belt to the seat;
a switch within the buckle indicating whether the buckle is in a buckled state or an unbuckled state;
a transmitter; and
wherein the transmitter transmits a signal from the removable seat that is received by the receiver.

8. The seat belt buckle alert system of claim 7 wherein the transmitter is a wireless transmitter.

9. The seat belt buckle alert system of claim 8 wherein the wireless transmitter has operating frequencies of 443.92 MHz and 315 MHz

10. The seat belt buckle alert system of claim 8 wherein the receiver is a keyless entry receiver.

11. The seat belt buckle alert system of claim 8 wherein the receiver is a tire pressure and monitor system receiver.

12. The seat belt buckle alert system of claim 7 wherein the transmitter comprises:
a magnetic field generator mounted below the removable seat in the motor vehicle; and
a magnetic field receiver in magnetic resonance with the magnetic field generator and electronically connected to the buckle switch.

13. The seat belt buckle alert system of claim 12 wherein the transmitter is connected to the receiver by a wire.

14. The seat belt buckle alert system of claim 13 wherein the transmitter is a comparator that transmits a signal when a current in the magnetic field generator is altered by the magnetic field receiver being activated by the buckle switch being closed.

15. The seat belt buckle alert system of claim 13 wherein the receiver is the airbag control unit.

16. The seat belt buckle alert system of claim 7 further comprising:
a head unit in communication with the receiver, the head unit providing alert indicia to a display within the motor vehicle.

17. The seat belt buckle alert system of claim 7 further comprising:
a meter for in communication with the receiver, the meter providing alert indicia within the motor vehicle.
